(19) United States
(12) Patent Application Publication
(10) Pub. No.: US 2001/0010172 A1
(43) Pub. Date: Aug. 2, 2001

(54) Device and method for detecting movement of ejector plate

(75) Inventors: Hiroaki Kawasaki, Mobara-shi (JP); Yasuo Ishiwata, Mobara-shi (JP); Yutaka Hiroshima, Mobara-shi (JP); Chisato Akinari, Mobara-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUTABA DENSHI KOGYO KABUSHIKI KAISHA, Mobara-shi (JP)

(21) Appl. No.: 09/770,399

(22) Filed: Jan. 29, 2001

(30) Foreign Application Priority Data
Feb. 2, 2000 (JP) 2000-025368

(51) Int. Cl. G01L 7/20

(52) U.S. Cl. 73/384

(57) ABSTRACT

An ejector plate movement detector is provided that can be mounted, without complicatedly machining a mold tool and occupying an installation place, and can detect movement of an ejector plate, with damages of parts suppressed to a necessary minimum. The detector 21A comprises a rod-like pin 22; a pressure detector 23 integrally attached on one end of the pin 22 and mounted on the ejector plate 12, for detecting the pressure applied via the pin 22 when the ejector plate 12 is moved forward and backward; a biasing member 24 for always biasing the ejector plate 12 to its original position with respect to the pin 22; and a holder 25 having one end fixedly mounted to the receiving plate 6, for housing said biasing means 24 and movably holding the pin against the biasing means 24. Whether or not the ejector plate 12 is normally moved is checked by monitoring waveforms of output values from the pressure sensor 27 before and after the movement of the ejector plate 12 at the ejection of a molded piece.

### BACKGROUND OF THE INVENTION

1. Field of the Invention

The present invention relates to an ejector plate movement detector built in a molding metal tool (hereinafter abbreviated to mold tool), in the field of injection molding technique and the field of die-casting technique. The ejector plate movement detector detects whether or not an ejector plate has returned to its normal position after the forward and backward movement of an ejector plate caused ejector pins to push a molded piece out of a mold tool. Moreover, the present invention relates to an ejector plate movement detecting method.

2. Description of the Related Art

Conventionally, a mold tool 1, as shown in FIG. 7, is used to form a desired molded piece through the injection molding. The whole configuration of the mold tool 1 will be explained later. In order to make a molded piece using the mold tool 1 shown in FIG. 7, a movable mold plate 5 with a core 5a is relatively moved toward a stationary mold plate 4 with a cavity 4a to close the mold tool 1. Then, a resin material to be plasticized is injected into the cavity 4a. When a suitable cooling period passes after completion of the injection, the movable mold plate is separated from the stationary mold plate 4 to open the mold tool 1. By moving the ejector pin 12, a molded piece is pushed out of the mold tool 1 with the ends of ejector pins 14.

In the conventional mold tool, because of the dragging of an ejector pin 14, the ejector plate 12 does not sometimes return to its original position after completely ejecting a molded piece. The operation continued with noticing such a phenomenon may cause a serious trouble such as a damage of a mold tool.

The following causes of an abnormal movement of the ejector plate 12 may be considered. That is, (1) when the molded piece within the cavity 4a is not drawn through penetration of the ejector pin 14, the ejector pin 14 may bend because of the excessive load thereon. (2) A foreign matter (dust) between the movable mounting plate 3 and the ejector plate 12 disturbs the retraction of the ejector plate 12. (3) A foreign matter invaded into the space between the stationary retainer plate 4 and the variable retainer plate 5 may prevent the mold tool 1 from being closed. (4) When the ejector pin 14 is pushed out through the movement of the ejector plate 12, an excessive load applied on the ejector pin 14 may bend the ejector pin 14. (5) Because of an excessive load on the return pin 16, the return pin 16 may be bent at the retraction of the ejector plate 12.

In the conventional structure, the limit switch 71 is buried in the variable retainer plate 3 to turn it on, with the ejector plate 12 returned to its original normal position, as shown in FIG. 7. The returning of the ejector plate 12 is confirmed by the on/off operation of the limit switch 71.

An externally-added configuration is well known where the limit switch 71 mounted outside the variable retainer plate 3 and a working piece mounted on the ejector plate 12 to turn on and off the limit switch 71.

However, in the conventional configuration, shown in FIG. 7, the variable retainer plate 3 must be specially machined to bury the limit switch 71 in it and to take the signal lines out of the limit switch 71.

Moreover, the conventional configuration of the type having a limit switch externally attached requires a new place (space) for mounting the limit switch 71. This attachment requires giving special consideration to the treatment of the mold tool.

In the limit-switch built-in conventional configuration, the limit switch 71 is merely turned mechanically on and off when the ejector plate 12 is contacted to and separated from the limit switch 71. It is decided that the ejector plate 12 has not returned to its original normal position when the limit switch 71 is not turned on after a predetermined lapse of time from the off state thereof. As a result, the state of the ejector plate 12 cannot be detected during the movement of the ejector plate 12. For that reason, when it is detected that the ejector plate 12 has not returned to its original normal position, the ejector pin 14 or the return pin 16 may be in a bent state. This bending may bring the mold tool 1 to the worst case or to an unusable state.

### SUMMARY OF THE INVENTION

The present invention is made to solve the above-mentioned problems.

Moreover, an objective of the invention is to provide an ejector plate movement detector that can be mounted, without complicatedly machining a mold tool and occupying its installation place, compared with the conventional configuration, and can detect the movement of ejector plates, with damages of parts suppressed to a necessary minimum.

Another objective of the present invention is to provide an ejector plate movement detecting method.

In order to achieve the above mentioned objects, an ejector plate movement detector that detects whether or not an ejector plate has been normally moved, the ejector plate movement detector being built in a molding metal tool, the molding metal tool including a first mold plate having a cavity and a second mold plate which has a core and is relatively movable to the first mold plate, the first mold plate and the first mold plate being combined together, the molding metal tool forming a molded piece by filling a space between the cavity and the core with a resin material, the ejector plate having an ejector pin pushing the molded piece out of the first and second mold plates using the point thereof when the first mold plate and the second mold plate are relatively separated from each other, the ejector plate movement detector comprises a rod-like pin; a pressure detector integrally attached on one end of the pin and mounted to the ejector plate, for detecting the pressure received via the pin when the ejector plate is moved forward and backward; a biasing member for always biasing the ejector plate to its original position with respect to the pin; and a holder having one end in contact with the second mold plate, for housing the biasing member and movably holding the pin against the biasing member.

According to the present invention, the ejector plate movement detector further comprises a return pin mounted on the ejector plate, for pushing the ejector pin back to a predetermined position by means of the first mold plate when the molding metal tool is closed, thus returning the ejector pin to a prescribed position.

In the ejector plate movement detector according to the present invention, the pin has a flange which has a spherical contact surface with a predetermined radius of curvature and the pressure detector comprises a box for housing the flange of the pin and a pressure sensor formed of an electric-resistance strain gauge, the electric-resistance strain gauge being mounted on a substrate inside the box and engaged with the contact surface of the flange.

In the ejector plate movement detector according to the present invention, the ejector plate comprises two plates arranged in parallel and spaced from each other a predetermined distance, the box being fixedly placed in a space between the two plates; and signal lines being led out of the pressure detector through the space.

Moreover, in an ejector plate movement detecting method detects whether or not an ejector plate having an ejector pin has been normally moved, by combining together a first mold plate having a cavity and a second mold plate which has a core and is relatively movable to the first mold plate, filling a space between the cavity and said core with a resin material to form a molded piece, and pushing the molded piece out of the first and second mold plates by means of the point of the ejector pin when the first mold plate and the second mold plate are relatively separated from each other, the ejector plate movement detecting method comprises the step of detecting whether or not the ejector plate has normally moved based on changes in pressure when the ejector plate moves forward or backward.

### BRIEF DESCRIPTION OF THE DRAWINGS

This and other objects, features, and advantages of the present invention will become more apparent upon a reading of the following detailed description and drawings, in which:

FIG. 1 is a cross-sectional view illustrating the whole structure of a mold tool incorporating a detector according to an embodiment of the present invention;

FIG. 2 is a cross-sectional view illustrating a detector built in the mold tool shown in FIG. 1, according to the first embodiment of the present invention;

FIG. 3 is an enlarged cross-sectional view illustrating the pressure detector of FIG. 1;

FIG. 4(a) is a plan view illustrating a pressure detector;

FIG. 4(b) is a cross-sectional view illustrating the pressure detector of FIG. 4(a);

FIG. 5 is a view illustrating a detector built in the mold tool shown in FIG. 1, according to the second embodiment of the present invention;

FIG. 6 is a view illustrating an example of an output value of a pressure sensor at which an ejector plate is moved back to an original normal position after a molded piece is protruded out of a mold tool in open; and

FIG. 7 is a cross-sectional view illustrating the whole structure of a mold tool in which a conventional detector is mounted.

### DETAILED DESCRIPTION OF THE PREFERED EMBODIMENTS

An ejector-plate movement detector according to embodiments of the present invention will be described below with reference to the attached drawings.

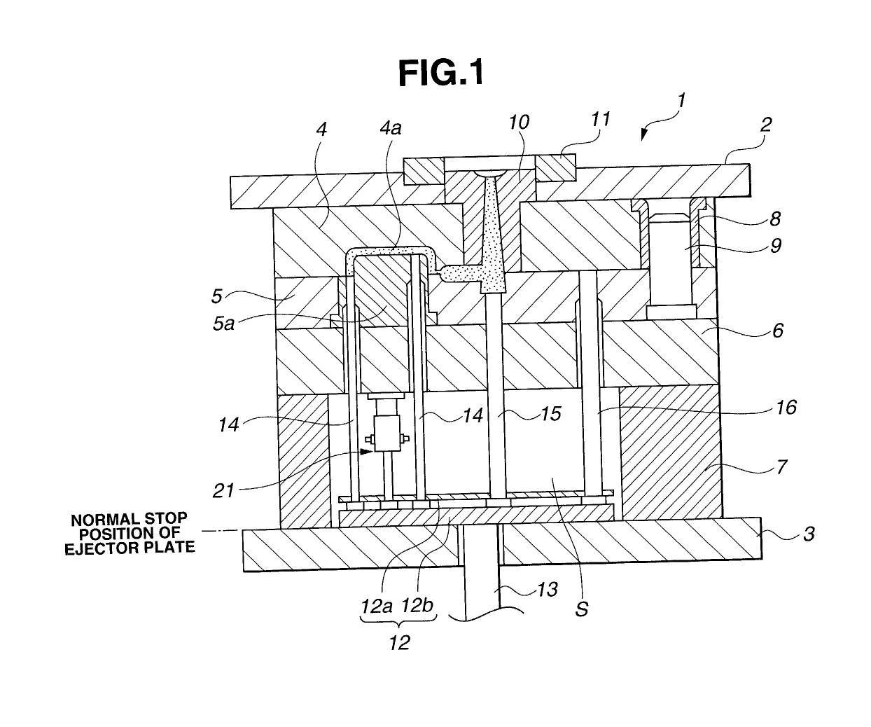

FIG. 1 is a cross-sectional view illustrating the whole structure of an ejector-plate movement detector according to an embodiment of the present invention.

The whole structure of a mold tool embodying an ejector plate movement detector according to each embodiment will be described by referring to FIG. 1.

A mold tool 1, as shown in FIG. 1, includes a stationary mounting plate 2 attached to the stationary holder of a molding machine and a variable mounting plate 3 attached to the variable holder of the molding machine.

The stationary mold plate (first retainer plate) having the cavity 4, being a female retainer plate, is attached to the stationary mounting plate 2. A variable mounting plate 5 (second retainer plate) having a core 5a, being a male retainer plate, is attached to the variable mounting plate 3 via the backing plate 6 and via the spacer block 7.

The mold tool 1 is dividable between the stationary retainer plate 4 and the variable retainer plate 5. The variable retainer plate 5 moves toward the stationary retainer plate 4 in the direction perpendicular to the plate surface in cooperation with movement of the holder of the molding machine. Thus, the stationary retainer plate 4 and the variable retainer plate 5 can be separated from each other.

A guide bush 8 is disposed in the stationary retainer plate 4. The guide post 9 is arranged in the variable retainer plate 5. The guide post 9 is slidably inserted into the guide bush 8. The stationary retainer plate 4 and the variable retainer plate 5 are opened and closed in accordance with the guidance of the guide bush 8 and the guide post 9. When the stationary retainer plate 4 and the variable retainer plate 5 are closed to each other, the cavity 4a and the core 5a are mated in an accurate alignment.

A sprue 10 and a locating ring 11 are formed to the stationary retainer plate 2. The sprue 10 is a runner for injecting a molten resin into the mold tool 1 from the nozzle of a cylinder in a molding machine. The locating ring 11 is a positioning member for mounting the mold tool 1 to the nozzle of the cylinder in the molding machine.

Two ejector plates 12 (12a, 12b), arranged in parallel and spaced at a predetermined distance, are fixed to the variable retainer plate 3. The variable retainer plate 3 is moved relatively to the ejector rod 13 when the molded piece is thrust (or when the mold tool is opened) while it is pushed by the ejector rod 13 with the variable retainer plate 3. Thus, the ejector plate 12 can be moved to a predetermined amount within the space S defined by the variable retainer plate 3, the backing plate 6, and the spacer block 7. The ejector plate 12 has ejector pins 14 each which is protruded from the core 4a when the mold tool 1 is opened to eject a molded piece out of the mold tool 1. An ejector pin 15 is disposed at the nearly center of the ejector plate 12 to eject an unnecessary liner formed within the sprue, together with the molded piece. An return pin 16 is disposed on the ejector plate 12 in such a way that the stationary retainer plate 4 pushes the ejector pins 14 and 15 back to a predetermined position when the mold tool 1 is closed.

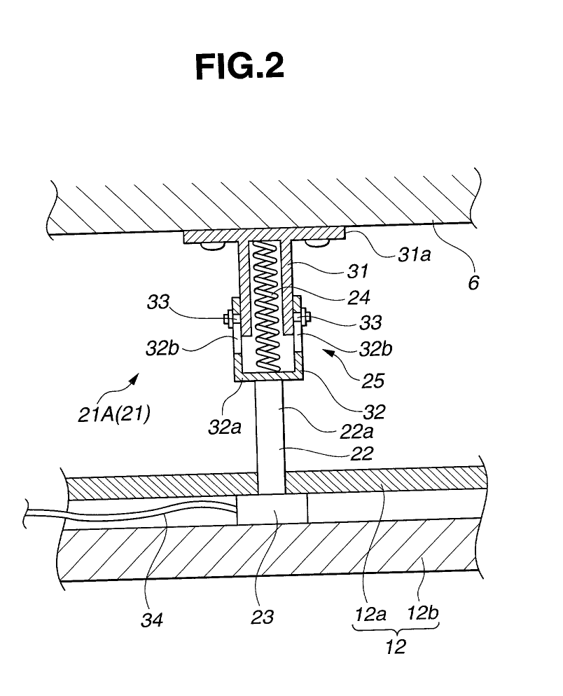

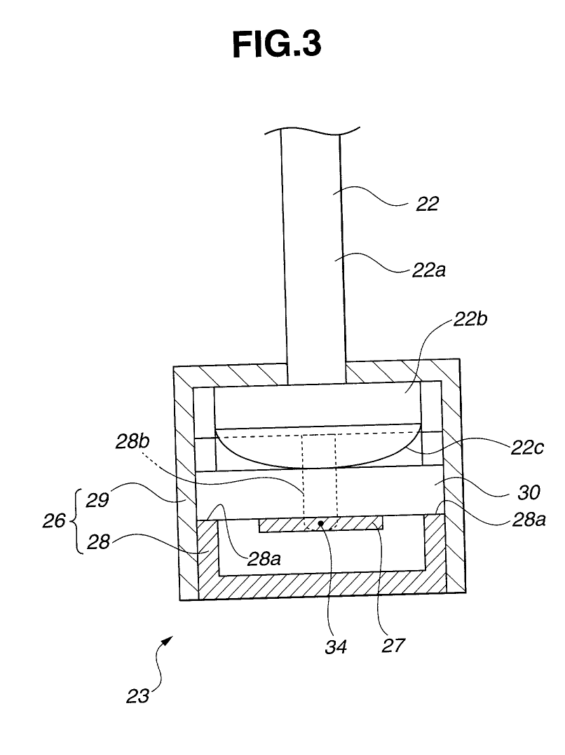

Next, FIG. 2 is a cross-sectional view illustrating an ejector plate movement detector according to the first embodiment, applied to a mold tool. FIG. 3 is an enlarged cross-sectional view illustrating pressure detecting means used for an ejector plate movement detecting device.

The ejector plate movement detector (hereinafter abbreviated as a detector) 21A (21) according to the first embodiment shown in FIG. 2 has a pin-like form similar to that of the ejector pin 14, 15. The detector 21A is disposed between the backing plate 6 on the movable side and the ejector plate 12.

The detector 21A consists of a rod-like pin 22, a pressure detector attached on end of the pin 22, a biasing member 24 for always applying a biasing force in the direction returning the ejector plate 12 attached to the other end of the pin 22 to the original position, and a holder for housing the biasing member 24 and movably holding the pin 22 against the biasing force of the biasing member 24.

The pin 22, as shown in FIG. 3, has a round rod 22a and a columnar flange 22b attached to the rear end of the rod 22a. The columnar flange 22b has an outer diameter larger than the rod 22a. The flange 22b has a spherical contact surface 22c having a predetermined curvature.

As shown in FIG. 3, the pressure detector 23 is integrally disposed to the flange 22b of the pin 22. In this example, the pressure detector 23 has a box 26 for housing the flange 22b of the pin 22 and a pressure sensor 27 disposed the inside of the box 26. The pressure detector 23 is securely fixed between two ejector plates 12a and 12b arranged at a predetermined interval. Signal lines 34 are taken out from the pressure sensor 27 via the gap between the ejector plates 12a and 12b to make predetermined conductors.

The box 26, as shown in FIG. 3, has a double cylindrical form where the inner cylinder 28 is disposed into the outer cylinder 29 under pressure.

Referring to FIG. 3, the inner cylinder 28 has the upper surface in open. The backup surface 28a on which the substrate 30 for the pressure sensor 27 is disposed is formed on the fringe of the upper surface. A notch 28b is formed on a portion of the peripheral wall surface of the inner cylinder 28 to lead the signal lines 34 of the pressure sensor 27 outside.

Referring to FIG. 3, the outer cylinder 29 has an upper surface of which the center has a through hole 29a and an lower surface in open. The rod-like portion 22a of the pin 22 penetrates the through hole 29a. A hole through which the signal line 34 of the pressure sensor 27 (described later) is led out is formed in a portion (not shown) of the peripheral wall surface of the outer cylinder 29.

In this example, the rod-like portion 22a of the pin 22 penetrates the center of the upper surface of the outer cylinder 28 while the flange 22b is housed within the box 26 and is in contact with the substrate 30 of the pressure sensor 27 (described later).

The pressure sensor 27, as shown in FIG. 3, is formed on the back surface of the substrate 30 disposed on the backup surface 28a of the inner cylinder 28 inside the box 26. In this example, the pressure sensor 27 is an electric-resistance strain gauge that detects the pressure using a change in resistance value change due to a strain of a resistance line under an external pressure.

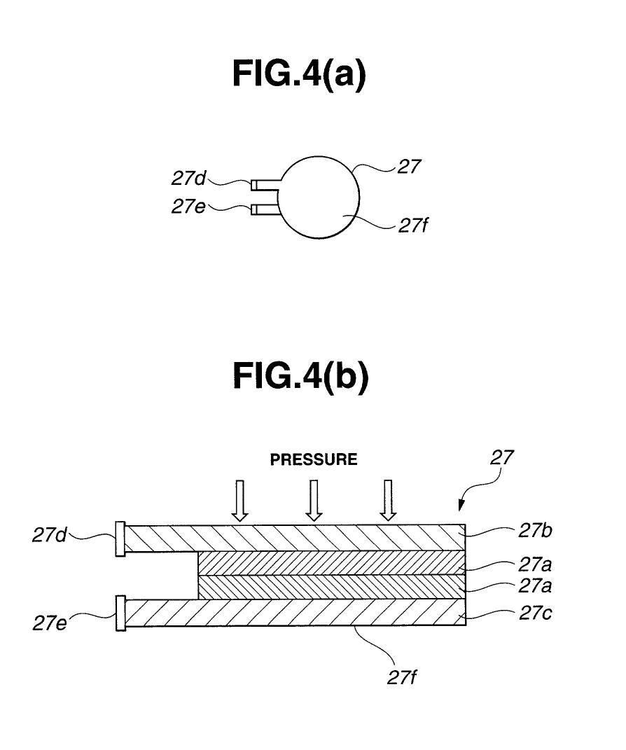

FIG. 4(a) is a plan view illustrating the pressure sensor 27. FIG. 4(b) is a cross-sectional view illustrating the pressure sensor 27. Referring to FIGS. 4(a) and 4(b), the pressure sensor 27 is a piezoelectric transducer. The piezoelectric transducer is formed of an upper silver electrode 27b, a lower silver electrode 27c, and two molybdenum sulfide layers (semiconductors) sandwiched between the electrodes 27a and 27a, a terminal 27d led from the upper electrode 27b, and a terminal 27e led from the lower electrode 27c. The whole structure is sealed with the insulator 27f such as polyimide. The pressure sensor 27 is very thin and slim and has, for example, a thickness of 0.08 mm and a diameter of about 5 mm.

The holder 25 has an inner cylinder 31 fixed on the backing plate 6 and an outer cylinder 32 movably attached to the inner cylinder 31. A spring 24 (such as a spring coil) as a biasing member is housed in the inner space enclosed by the inner cylinder 31 and the outer cylinder 32.

The inner cylinder 31 has one end to which a flange 31a is fixed to the backing plate 6 with fixing members such as screws and the other end in open. Two guide pins 33, 33 are inserted into the peripheral wall surface on the open side of the inner cylinder 31 so as to confront to each other.

The outer cylinder 32 has a diameter somewhat larger than the inner cylinder 31. The inner cylinder 32 has one end in open, which confronts the open end of the inner cylinder 31, and the other end being the flat surface 32a. Long holes 32b and 32b are formed in the peripheral wall surface of the outer cylinder 32 to confront to each other. Each of the long holes 32b, 32b is formed as nearly equal as the stroke of the ejector plate 12 along the longitudinal direction of the outer cylinder 32. The guide pins 33 are fixed with screws, with the guide pins 33 inserted in the long holes 32b, 32b of the inner cylinder 31, to prevent the cylinder 31 from being come out of the cylinder 32.

When the ejector plate 12 is at a normal position, the guide pins 33, as shown in FIG. 2, are positioned at the upper end of the long hole 32. When the ejector plate 12 reciprocates, each guide pin 33 on the inner cylinder 31 moves along the long hole 32b in the outer cylinder 32.

When the ejector plate 12 advances to eject a molded piece, the outer cylinder 32 moves upward (in FIG. 2) against the biasing force of the spring 24, thus compressing the spring 24. The compression of the spring 24 causes the down movement of the pin 22 (in FIG. 2). Thus, the contact surface 22c of the flange 22b of the pin 22 pushes and bends the substrate 30. The pressure sensor 27 produces the signal according to the bending of the substrate 30.

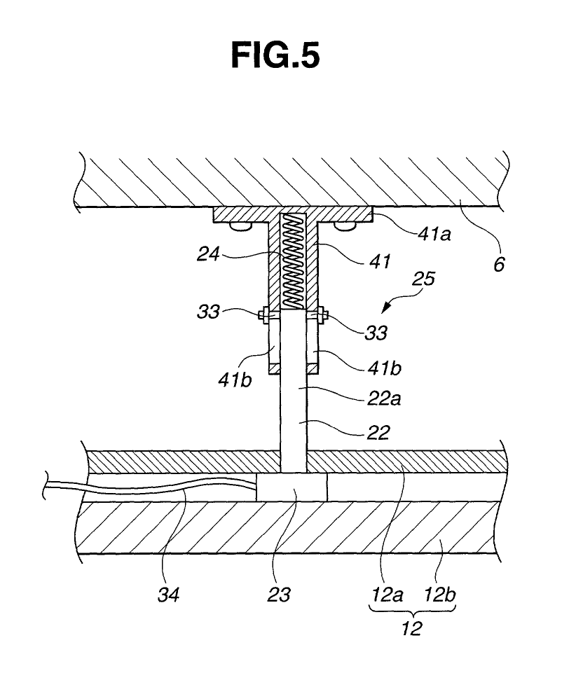

Next, FIG. 5 is a cross-sectional view illustrating a detector according to the second embodiment. Like numerals are attached to the same constituent elements as those in the detector 21A of the first embodiment shown in FIG. 2 and hence the duplicate explanation will be omitted here.

In the detector 21A, the spring 24 acting as a biasing member is housed inside the cylinders 31 and 32 in a telescopic state. The pin 22 has the pressure detector 23. The rod-like portion of the pin 22 is in contact with the flat surface 32a of the outer cylinder 32. However, in the detector 21B (21) of the second embodiment, a single cylinder 41 acting as a holder 25 houses a spring (biasing member) 24. The rod-like portion 22a of the pin 22 is in contact with one end of the spring 24.

In further explanation, the cylinder 41 has a flange 41a which has one end fixed to the backing plate 6 by means of screws and the other end in open. Two guide pins 33 and 33 are inserted into the end of the rod-like portion 22a of the pin 22 so as to confront to each other. Each of long holes 41b, 41b is formed as equal as the stroke of the ejector plate 12 along the longitudinal direction of the cylinder 41. Screws prevent the guide pin 22 from coming out of the cylinder 41, with the guide pin 33 of the pin 22 inserted into the guide pin 22 via the long holes 41b, 41b.

When the ejector plate 12 is at a normal position, the guide pin 33, as shown in FIG. 5, is positioned on the upper side of the long hole 41b. When the ejector plate 12 reciprocates, the guide pin 33 of the pin 22 moves along the long hole 41b in the cylinder 41.

Accordingly, when the ejector pin 12 advances to eject the molded piece, the pin 22 moves upward (in FIG. 2) against the biasing force of the spring 24, thus compressing the spring 24. The compression of the spring 24 causes the down movement (in FIG. 2) of the pin 22. The contact surface 22c of the flange 22b of the pin 22 pushes and bends the substrate 30. The pressure sensor 27 outputs the signal in accordance with the bending of the substrate 30.

In the mold tool 1 using the detector 21 (21A, 21B) with the above-mentioned structure, when the molded piece is ejected, the variable retainer plate 5 and the stationary retainer plate 4 are separated from each other, so that the mold tool 1 is opened. When the ejector plate 12 advances through the pushing of the ejector rod 13, the spring 24 acting as a biasing member is compressed in the holder 25. Thus, the contact surface 22c of the flange 22b of the pin 22 in the pressure detector 23 pushes and bends the substrate 30. The pressure sensor 27 produces a signal corresponding to the bending amount of the substrate 30.

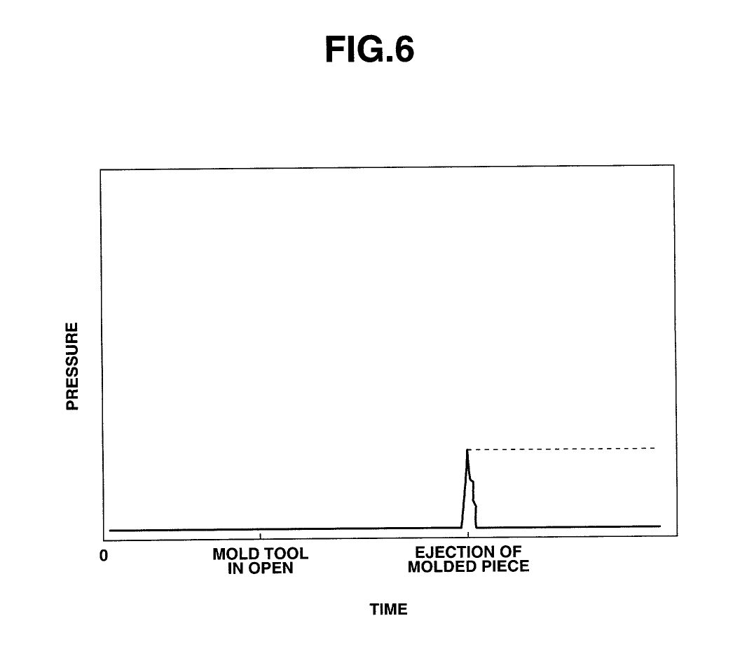

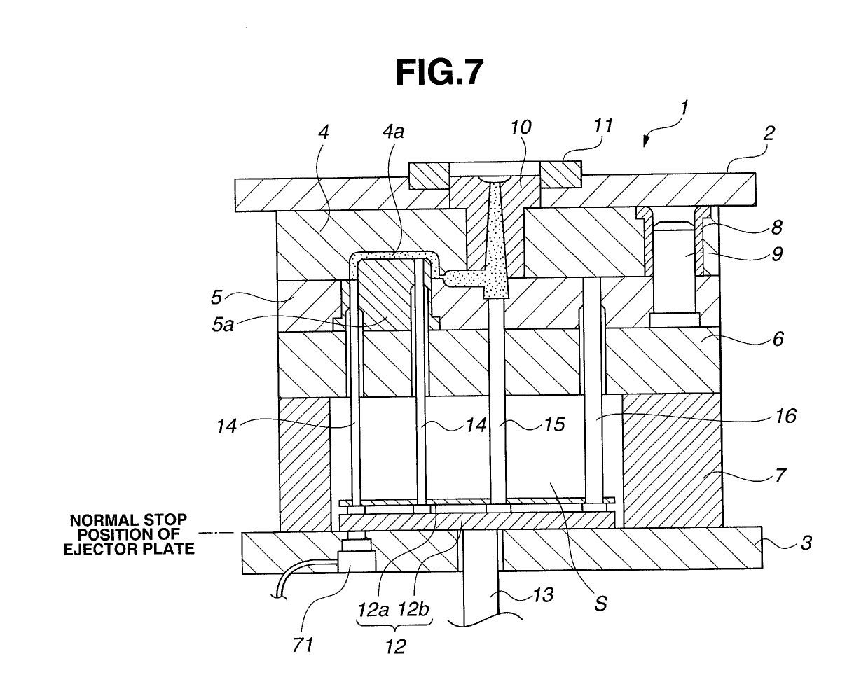

FIG. 6 illustrates an example of an output value which is output by the pressure sensor 27 while the ejector plate 12 is returning to the original normal position after the ejection of the molded piece following the opening of the mold tool 1.

The ejector rod 13 returns back after complete ejection of a molded piece by the ejector pin 14 (15) while the ejector plate 12 normally returns to the original normal position. At this time, the spring 24 returns to the original position so that the bending of the substrate 30 is eliminated. As a result, the pressure sensor 27 produces an output value of zero, as shown with solid lines in FIG. 6.

If the ejector plate 12 does not return to its original position because of a cause such as dragging of the ejector pin 14, the spring 24 remains compressed. Thus, the output value of the pressure sensor 27 is not set to zero but indicates the output value corresponding to the position of the ejector plate 12. For example, when the ejector pin 14 sticks at the position where the ejector pin 14 pushes out a molded piece, the pressure sensor 27 produces a peak output value, as shown in FIG. 6.

The output value of the pressure sensor 27 is monitored on, for example, the display screen before and after the ejection of a molded piece. By monitoring the waveform of the output value of the pressure sensor 27, whether or not the ejector plate 12 is normally moving is checked. For example, when the ejector plate 12 advances or retracted, the gradient (change rate) of the output waveform of the pressure sensor 27 may be moderate, compared with that of the output waveform of the pressure sensor 27 in the normal movement of the ejector plate 12. In such a case, an extra load is applied on the ejector pin 14 and the return pin 16. As a rsult, it is assumed that the movement of the ejector plate 12 is disturbed.

In the structure and method using the detector 21 (21A, 21B) in this embodiment, the movement of the ejector plate 12 can be always monitored as a change in waveform of a pressure value of the pressure sensor 27 during movement of the ejector plate 12 on the display screen. Thus, the damage of parts (the ejector pins 14, 15 and the return pin 16) because of an abnormal movement of the ejector plate 12 can be suppressed to a necessary minimum and the movement of the ejector plate 12 can be detected.

The detector 21 in this embodiment has the configuration where the box 26 for the pressure detector 23 is securely sandwiched between two ejector plates 12a and 12b arranged in parallel. In order to assemble the detector 21 to the mold tool 1, a hole is formed in the ejector plate 12a to penetrate the rod-like portion 22a of the pin 22. The signal line 24 of the pressure sensor 27 in the detector 21 built in the mold tool 1 can be led out via the space between two ejector plates 12a and 12b. The detector 21 does not occupy the installation place, compared with the conventional one, and can be mounted without specially machining the mold tool.

If there is a foreign matter between the movable retainer plate 3 and the ejector plate 12, the detector can detect the abnormal state, without providing an additional means such as springs, thus stopping the ejector plate 12.

Moreover, by monitoring the peak output value of the pressure sensor 27 of the detector 21, whether or not the ejector pin 14 has ejected a molded piece out of the mold tool 1 can be checked.

Since the spring (biasing means) 24, which is disposed within the holder 25 of the detector 21, always biases the ejector plate 12 so as to return it in the direction of the normal position. The biasing force assists to forcibly return the ejector plate 12 to the normal position after the molded piece is ejected out of the mold tool 1 so that the ejector plate can be quickly returned to its normal position. In this operation, if there is a foreign matter between the variable retainer plate 3 and the ejector plate 12, an abnormal state due to the foreign matter is detected before the closure of the mold tool 1 causes the return pin 16 to become in contact with the stationary retainer plate 4. Thus, the movement of the variable retainer plate 5 and the ejector plate 12 can be stopped.

The detector 21B in the second embodiment is fixed to the backing plate 6 via the flange 41a of the cylinder 41. However, it is not essential to fix the cylinder 41 to the backing plate 6. Such a structure can omit fixing members as screws for fixing the flange 41a and the flange 41a to the backing plate 6.

If the detector can detect the load imposed on the ejector plate 12 in terms of pressure, the detector is not limited to the illustrated configuration.

Moreover, the detector 21 can employ for mold tools used in other injection molding technical fields or die-casting technical fields, without being limited to the mold tool 1 shown in FIG. 1. For example, the mold tool in which a spring (coil spring) is built in the return pin 16 can be used as the biasing means for returning the ejector plate 12. If such a mold tool uses the detector 21 in the embodiment, the ejector plate 12 can be returned more quickly to the original normal position, in cooperation with the biasing force of the spring 24 acting the biasing means attached to the detector 21.

As clearly understood from the above-mentioned explanation, the movement of the ejector plate can be always monitored as variations in waveform of a pressure value of the pressure sensor during movement of the ejector plate.

For example, there is a foreign matter between the variable retainer plate and the ejector plate, the abnormal state can be detected without preparing an additional biasing means such as a spring, so that the movement of the ejector plate can be stopped.

By monitoring the peak output value of the pressure sensor, it can be checked whether or not the ejector pin has ejected a molded piece out of the mold tool.

According to the invention defined in claim 2, the biasing means attached to the holder always applies a biasing force to the pin in the direction of returning the ejector plate to the normal position. Therefore, the biasing force assists to forcibly return the ejector plate to the normal position after the molded piece is pushed out of the mold tool. As a result, the ejector pin can be quickly returned to the normal position. In this operation, when there is a foreign matter between the variable retainer plate and the ejector plate, the abnormal state due to the foreign matter can be detected before the stationary retainer plate becomes in contact with the return pin by the closure of the mold tool. As a result, the movement of the variable retainer plate and the ejector plate can be stopped.

According to the invention defined in claim 4, since the box of the pressure detector is fixedly sandwiched between the two ejector plates, a pin accepting hole can be merely formed in an ejector plate. Moreover, the signal lines from the pressure sensor in the detector built in the mold tool can be led out via the space surrounded by the two ejector plates. Hence, the detector can be installed at a smaller area, compared with the conventional one, and can be attached without specially machining the mold tool.

What is claimed is:

1. An ejector plate movement detector that detects whether or not an ejector plate has been normally moved, said ejector plate movement detector being built in a molding metal tool, said molding metal tool including a first mold plate having a cavity and a second mold plate which has a core and is relatively movable to said first mold plate, said first mold plate and said first mold plate being combined together, said molding metal tool forming a molded piece by filling a space between said cavity and said core with a resin material, said ejector plate having an ejector pin pushing said molded piece out of said first and second mold plates using the point thereof when said first mold plate and said second mold plate are relatively separated from each other, said ejector plate movement detector comprising:
a rod-like pin;
a pressure detector integrally attached on one end of said pin and mounted to said ejector plate, for detecting the pressure received via said pin when said ejector plate is moved forward and backward;
a biasing member for always biasing said ejector plate to its original position with respect to said pin; and
a holder having one end in contact with said second mold plate, for housing said biasing member and movably holding said pin against said biasing member.

2. The ejector plate movement detector defined in claim 1, further a return pin mounted on said ejector plate, for pushing said ejector pin back to a predetermined position by means of said first mold plate when said molding metal tool is closed, thus returning said ejector pin to a prescribed position.

3. The ejector plate movement detector defined in claim 1 or 2, wherein said pin has a flange which has a spherical contact surface with a predetermined radius of curvature and wherein said pressure detector comprises a box for housing said flange of said pin and a pressure sensor formed of an electric-resistance strain gauge, said electric-resistance strain gauge being mounted on a substrate inside said box and engaged with the contact surface of said flange.

4. The ejector plate movement detector defined in any one of claims 1 to 3, wherein said ejector plate comprises two plates arranged in parallel and spaced from each other a predetermined distance, said box being fixedly placed in a space between said two plates; and signal lines being led out of said pressure detector through said space.

5. An ejector plate movement detecting method detects whether or not an ejector plate having an ejector pin has been normally moved, by combining together a first mold plate having a cavity and a second mold plate which has a core and is relatively movable to said first mold plate, filling a space between said cavity and said core with a resin material to form a molded piece, and pushing said molded piece out of said first and second mold plates by means of the point of said ejector pin when said first mold plate and said second mold plate are relatively separated from each other, said ejector plate movement detecting method comprises the step of:
detecting whether or not said ejector plate has normally moved based on changes in pressure when said ejector plate moves forward or backward.
